(19) United States
(12) Patent Application Publication
(10) Pub. No.: US 2025/0303582 A1
(43) Pub. Date: Oct. 2, 2025

(54) AUTOMATIC MATERIAL TURNING CNC EQUIPMENT LOADING AND UNLOADING MACHINE

(71) Applicant: Shenzhen FSJ Intelligent Technical Co., Ltd., Shenzhen, Guangdong (CN)

(72) Inventor: Xuehong Liu, Shenzhen, Guangdong (CN)

(21) Appl. No.: 18/864,501

(22) PCT Filed: Apr. 24, 2023
(86) PCT No.: PCT/CN2023/090224

§ 371 Date: Nov. 8, 2024

(30) Foreign Application Priority Data
May 11, 2022 (CN) 202210510548.5

(51) Int. Cl. B25J 15/00; B25J 11/00

(52) U.S. Cl. CPC B25J 15/0004; B25J 11/0055; B25J 15/0052

(57) ABSTRACT

The present invention discloses an automatic material turning CNC equipment loading & unloading machine, belonging to the field of mechanical processing, and the automatic material turning CNC equipment loading & unloading machine can complete the automatic loading & unloading of workpieces, and the automatic turning of multiple processed surfaces and automatic rotation of locating surfaces during process conversion through the addition of a multi processed surface automatic turning mechanism and a locating surface rotation mechanism; assisted by the automatic cooperation of clamping jaw grasping mechanism, the automatic material turning CNC equipment loading & unloading machine significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### TECHNICAL FIELD

The present invention relates to the field of mechanical processing, and more specifically, to an automatic material turning CNC equipment loading & unloading machine.

### BACKGROUND

CNC equipment truss manipulator is composed of a set of truss manipulators, material grasping mechanisms on the manipulators, and material preparation racks outside the CNC equipment. Taking the CNC machining center as an example, the working method is described as follows: grab the workpiece to be machined to the workpiece clamping point at the table clamp (or other clamping mechanism) of the CNC machining center (or similar CNC machining equipment) using the clamping jaw grasping mechanism on the truss manipulator, take away the processed product (no processed product for the first time), place and clamp the product to be processed, and the truss manipulator leaves the CNC machining center to place the workpiece back on the workpiece tray, repeating the above cycle. Traditional truss manipulators can only complete the clamping of one processed surface, and cannot automatically clamp workpieces with multiple processing steps on a single machine, or depends on the manual turning of workpiece to achieve the production of workpieces with multiple processing steps on a single machine, resulting in high labor costs, low production efficiency, and insufficient utilization of the machine; or the use of a workpiece logistics and distribution system leads to a complex and large process, too much occupied space and difficult implementation, as well as high cost; or the combined use of multiple CNC machining centers and loading & unloading truss manipulators result in high costs and uneven machine ratios, leading to idle machines and slower workpiece circulation.

### SUMMARY

### 1. Technical Problems to be Solved

In response to the problems in the prior art, the present invention aims to provide a automatic material turning CNC equipment loading & unloading machine that can complete the automatic loading and unloading of workpieces, and the automatic turning of multiple processed surfaces and automatic rotation of locating surfaces during process conversion through the addition of a multi processed surface automatic turning mechanism and a locating surface rotation mechanism; assisted by the automatic cooperation of clamping jaw grasping mechanism, the automatic material turning CNC equipment loading & unloading machine significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### 2. Technical Solution

To address the above problems, the present invention adopts the following technical solution.

For the automatic material turning CNC equipment loading & unloading machine, the truss manipulator is provided with a clamping jaw grasping mechanism having four clamping jaws, the truss manipulator is fixedly connected to a material preparation rack that is provided with a multi processed surface automatic turning mechanism, a locating surface rotation mechanism, and material tray I, and the automatic material turning CNC equipment loading & unloading machine can complete the automatic loading and unloading of workpieces, and the automatic turning of multiple processed surfaces and automatic rotation of locating surfaces during process conversion through the addition of a multi processed surface automatic turning mechanism and a locating surface rotation mechanism; assisted by the automatic cooperation of clamping jaw grasping mechanism, the automatic material turning CNC equipment loading & unloading machine significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

In further, the truss manipulator is installed on the ground, used to drive the clamping jaw grasping mechanism to move according to the programmed trajectory, and to load and unload materials for the CNC equipment, the truss manipulator comprises a first fixed bracket, the outer end of the first fixed bracket is connected to a first guide rail and a second fixed bracket, the outer end of the first guide rail is connected to a first movable bracket that performs lateral movement along the X-axis, and is provided with the first movable bracket power mechanism, the outer end of the first movable bracket is connected to a second guide rail, the outer end of the second guide rail is connected to a second movable bracket that performs longitudinal movement along the Y-axis, and is provided with the second movable bracket power mechanism, and the outer end of the second movable bracket is connected to a third guide rail, and the outer end of the third guide rail is connected to a third movable bracket that performs up and down movement along the Z-axis, and is provided with a third movable bracket power mechanism.

In further, the clamping jaw grasping mechanism comprises a first rotation mechanism, a first clamping jaw grasping mechanism, a second clamping jaw grasping mechanism, a third clamping jaw grasping mechanism, and a fourth clamping jaw grasping mechanism, respectively provided with a first clamping jaw, a second clamping jaw, a third clamping jaw, and a fourth clamping jaw; the first rotation mechanism is disposed on the third movable bracket and can rotate 180 degrees; the first clamping jaw, second clamping jaw, third clamping clamping jaw, and fourth clamping jaw are divided into two groups, and the first group includes the first and second clamping jaw grasping mechanisms, respectively provided with the first and second telescopic mechanisms, and the second group includes the third and fourth clamping jaw grasping mechanisms.

In further, the multi processed surface automatic turning mechanism comprises a third telescopic mechanism, a fourth telescopic mechanism, accordingly provided with the third and fourth power mechanisms, a second rotation mechanism, and a third rotation mechanism, and accordingly provided with the second and third power mechanisms, and with the fifth and sixth clamping jaws, the third and fourth telescopic mechanisms are disposed on the second fixed bracket, the second rotation mechanism is disposed on the third telescopic mechanism, the third rotation mechanism is disposed on the fourth telescopic mechanism, the fifth clamping jaw is disposed on the second rotation mechanism, and the sixth clamping jaw is disposed on the third rotation mechanism; the locating surface rotation mechanism includes a fifth telescopic mechanism having the corresponding power mechanism, and a fourth rotation mechanism having the corresponding power mechanism and material tray II.

In further, material tray I, material tray II, material tray III, material tray IV, material tray V, material tray VI, and material tray VII are provided with a plurality of clamping positions according to the needs of processed workpiece.

### 3. Beneficial Effects

Compared to prior art, the present invention has the following advantages:

In this solution, the automatic material turning CNC equipment loading & unloading machine can complete the automatic loading and unloading of workpieces, and the automatic turning of multiple processed surfaces and automatic rotation of locating surfaces during process conversion through the addition of a multi processed surface automatic turning mechanism and a locating surface rotation mechanism; assisted by the automatic cooperation of clamping jaw grasping mechanism, the automatic material turning CNC equipment loading & unloading machine significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### BRIEF DESCRIPTION OF THE DRAWINGS

FIG. 1 is an overall perspective view of the present invention;

FIG. 2 is a perspective view of truss manipulator part of the present invention;

FIG. 3 is a perspective view of second fixed bracket part of the present invention;

FIG. 4 is a sectional view of clamping jaw grasping mechanism of the present invention;

FIG. 5 is a perspective view of clamping jaw grasping mechanism of the present invention;

FIG. 6 is a three view diagram of clamping jaw grasping mechanism of the present invention;

FIG. 7 is a perspective view of second turning mechanism of the present invention.

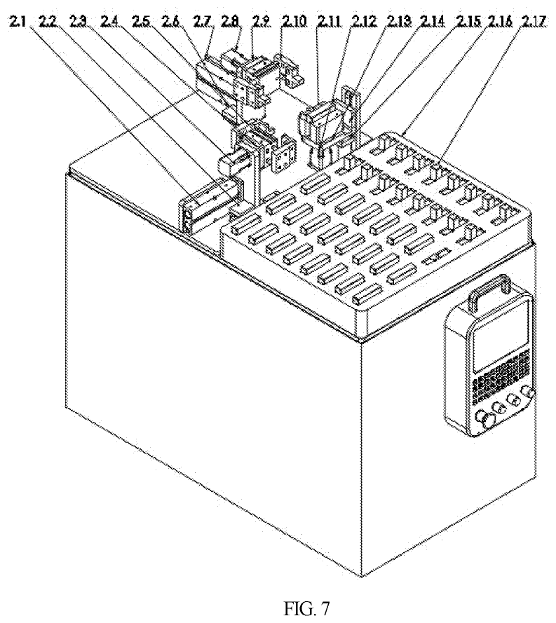

The numbering in the figure indicates:

1. Truss manipulator; 2. Second fixed bracket; 201. Third telescopic mechanism; 202. Second rotation mechanism; 203. Fifth clamping jaw; 204. Third rotation mechanism; 205. Material tray II; 206. Fourth telescopic mechanism; 207. Fourth rotation mechanism; 208. Material tray III; 209. Fifth telescopic mechanism; 210. Fifth rotation mechanism; 211. Material tray IV; 212. Sixth telescopic mechanism; 213. Seventh telescopic mechanism; 214. Seventh telescopic mechanism; 215. Sixth clamping jaw; 216. Material tray VI; 217. Eighth rotation mechanism; 218. Material tray VII; 219. Ninth telescopic mechanism; 220. Tenth telescopic mechanism; 221. Ninth rotation mechanism; 222. Material tray V; 223. Eighth telescopic mechanism; 224. Seventh rotation mechanism; 225. First fixed bracket; 226 Material tray I; 227. Workpiece; 3. Clamping jaw grasping mechanism; 301. Fourth clamping jaw; 302 First rotation mechanism; 303. First rotation mechanism power structure; 304. First telescopic mechanism; 305. First clamping jaw; 306 second telescopic mechanism; 307. Second clamping jaw; 308. Third clamping jaw; 4. Teach pendant; 5. CNC equipment telescopic door, 6. Positioning clamping mechanism, 7. CNC equipment.

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In the description of the present invention, it should be noted that the terms “up”, “down”, “inside”, “outside”, “top/bottom”, etc. indicate orientation or position relationships based on the orientation or position relationships shown in the accompanying drawings, only for the convenience of describing the present invention and simplifying the description, and do not indicate or imply that the device or element referred to must have a specific orientation, be constructed and operated in a specific orientation, and therefore cannot be understood as limiting the present invention. In addition, the terms “first” and “second” are only used for descriptive purposes and cannot be understood as indicating or implying relative importance.

In the description of the present invention, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two components. The person having ordinary skill in the art can understand the specific meanings of the above terms in the present invention in specific situations.

### Embodiment 1

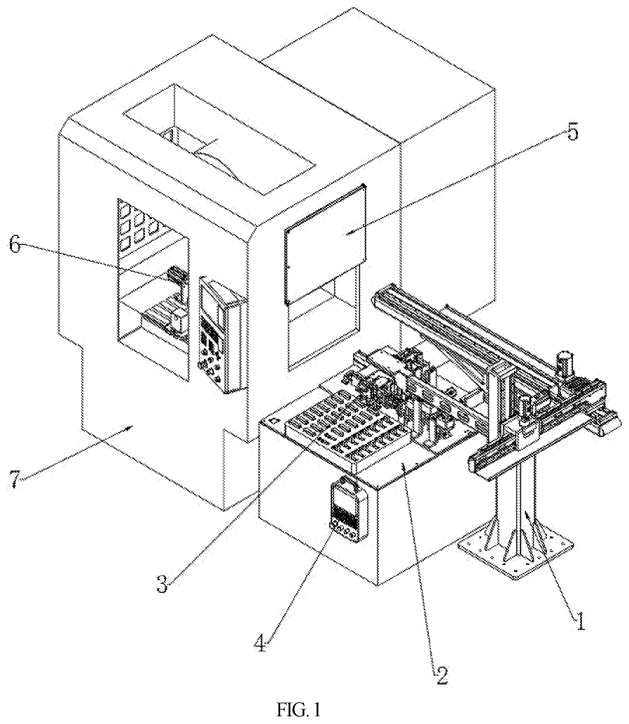

As shown in FIG. 1, for the automatic material turning CNC equipment loading & unloading machine, the truss manipulator is provided with a clamping jaw grasping mechanism having four clamping jaws, the truss manipulator is fixedly connected to a material preparation rack that is provided with a multi processed surface automatic turning mechanism, a locating surface rotation mechanism, and material tray I; the automatic material turning CNC equipment loading & unloading machine can complete the automatic loading and unloading of workpieces, and the automatic turning of multiple processed surfaces and automatic rotation of locating surfaces during process conversion through the addition of a multi processed surface automatic turning mechanism and a locating surface rotation mechanism; assisted by the automatic cooperation of clamping jaw grasping mechanism, the automatic material turning CNC equipment loading & unloading machine significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

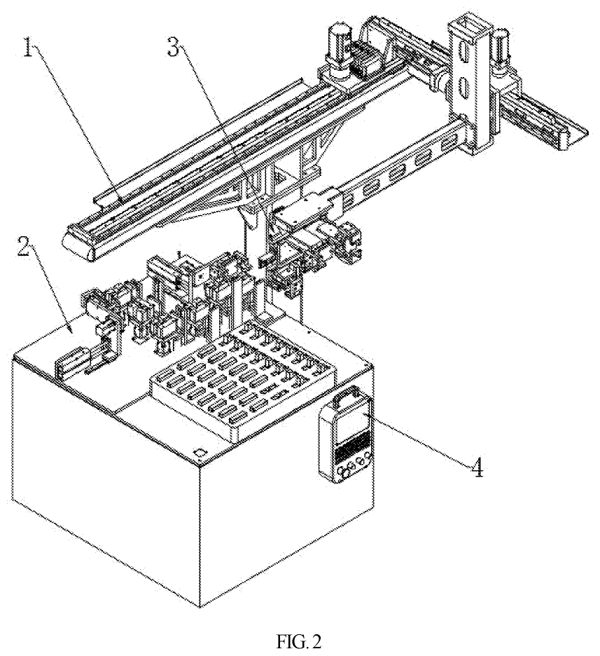

In FIG. 1-2, the truss manipulator is installed on the ground, used to drive the clamping jaw grasping mechanism to move according to the programmed trajectory, and to load and unload materials for the CNC equipment, the truss manipulator comprises a first fixed bracket, the outer end of the first fixed bracket is connected to a first guide rail and a second fixed bracket, the outer end of the first guide rail is connected to a first movable bracket that performs lateral movement along the X-axis, and is provided with the first movable bracket power mechanism, the outer end of the first movable bracket is connected to a second guide rail, the outer end of the second guide rail is connected to a second movable bracket that performs longitudinal movement along the Y-axis, and is provided with the second movable bracket power mechanism, and the outer end of the second movable bracket is connected to a third guide rail, and the outer end of the third guide rail is connected to a third movable bracket that performs up and down movement along the Z-axis, and is provided with a third movable bracket power mechanism.

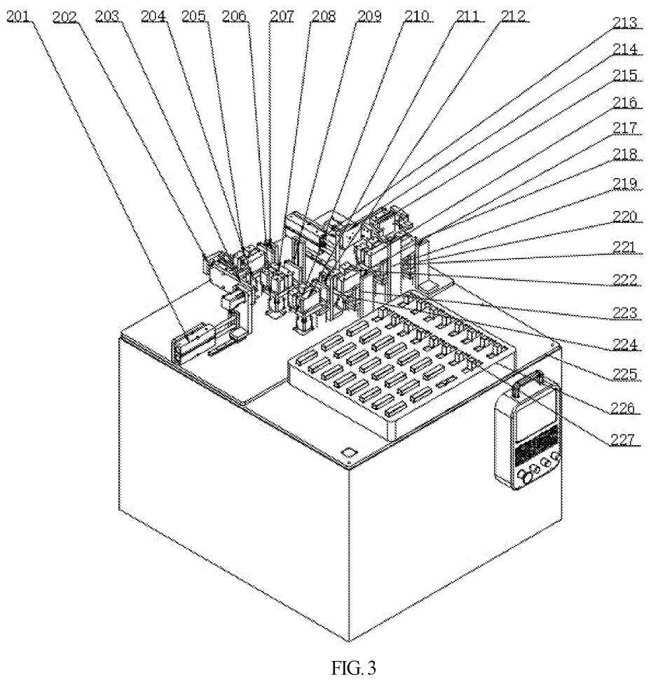

In FIG. 2-3, the clamping jaw grasping mechanism comprises a first rotation mechanism, a first clamping jaw grasping mechanism, a second clamping jaw grasping mechanism, a third clamping jaw grasping mechanism, and a fourth clamping jaw grasping mechanism, respectively provided with a first clamping jaw, a second clamping jaw, a third clamping jaw, and a fourth clamping jaw; the first rotation mechanism is disposed on the third movable bracket and can rotate 180 degrees; the first clamping jaw, second clamping jaw, third clamping jaw, and fourth clamping jaw are divided into two groups, and the first group includes the first and second clamping jaw grasping mechanisms, respectively provided with the first and second telescopic mechanisms, and the second group includes the third and fourth clamping jaw grasping mechanisms.

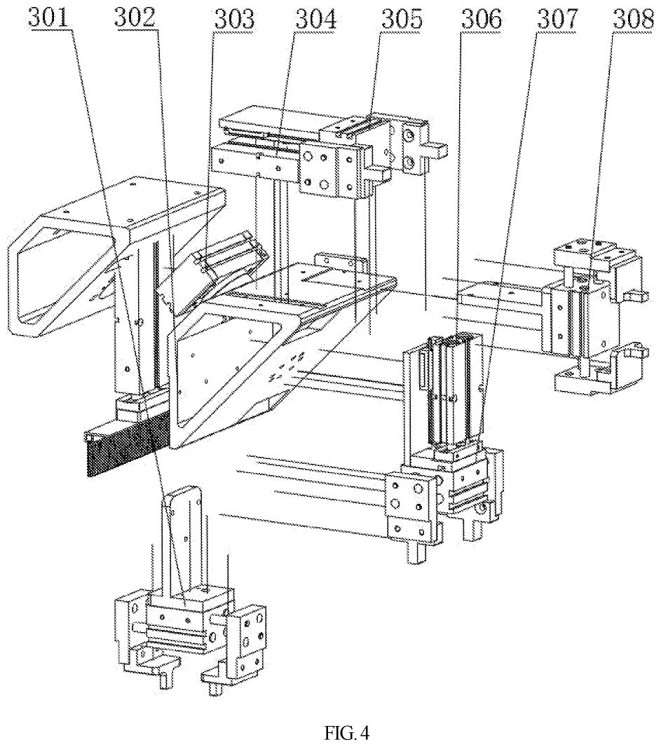

In FIG. 3-4, the multi processed surface automatic turning mechanism comprises a third telescopic mechanism, a fourth telescopic mechanism, accordingly provided with the third and fourth power mechanisms, a second rotation mechanism, and a third rotation mechanism, and accordingly provided with the second and third power mechanisms, and with the fifth and sixth clamping jaws, the third and fourth telescopic mechanisms are disposed on the second fixed bracket, the second rotation mechanism is disposed on the third telescopic mechanism, the third rotation mechanism is disposed on the fourth telescopic mechanism, the fifth clamping jaw is disposed on the second rotation mechanism, and the sixth clamping jaw is disposed on the third rotation mechanism; the locating surface rotation mechanism includes a fifth telescopic mechanism having the corresponding power mechanism, and a fourth rotation mechanism having the corresponding power mechanism and material tray II.

Material tray I, material tray II, material tray III, material tray IV, material tray V, material tray VI, and material tray VII are provided with a plurality of clamping positions according to the needs of processed workpiece.

Assuming workpieces are provided on the material trays, the unprocessed workpieces are arranged in sequence as A, B, and C and correspondingly, the workpieces that have been processed in the first process are A1, B1, C1 . . . , and the workpieces that have been processed in the second process are A2, B2, C2 . . . , and so on;

The first loading & unloading machine performs loading and unloading for the automatic turning CNC equipment with multi processed surface automatic turning and locating surface rotation mechanism according to the following processes:
\textcircled{1} Manually place unprocessed workpieces on material tray I of material preparation rack;
\textcircled{2} Through the clamping jaw grasping mechanism, truss manipulator grabs unprocessed workpiece A from material tray I and sends it to the appropriate position of workbench clamp at the CNC machining center, takes away the processed workpiece (no processed workpiece for the first time) and places unprocessed workpiece A on the workbench clamp which clamps automatically;
\textcircled{3} Truss manipulator leaves CNC machining center and moves to the vicinity of material tray II;
\textcircled{4} During workpiece machining at CNC machining center, truss manipulator places processed workpieces (no processed workpieces for the first time) onto material tray II;
\textcircled{5} Through the automatic turning of multi processed surfaces, locating surface rotation mechanism meets the requirements of turning the processed surface and rotating the locating surface (the processed surface has been turned and the locating surface has been rotated);
\textcircled{6} Through the clamping jaw grasping mechanism, truss manipulator grabs processed workpieces (no processed workpieces for the first time) from material tray II, moves and places them on material tray I;
\textcircled{7} Truss manipulator grabs the second unprocessed workpiece B from material tray I through the clamping jaw grasping mechanism, and moves it outside the CNC machining center;
\textcircled{8} After CNC machining center completes processing, truss manipulator moves to the vicinity of workbench clamp at CNC machining center, grabs processed workpiece A1 through the clamping jaw grasping mechanism, places unprocessed workpiece B on the workbench clamp which clamps automatically;
\textcircled{9} Truss manipulator leaves CNC machining center and moves to the vicinity of material tray II;
\textcircled{10} During workpiece processing at CNC machining center, truss manipulator places processed workpiece A1 onto material tray II;
\textcircled{11} Through the automatic turning of multi processed surfaces, locating surface rotation mechanism meets the requirements of turning the processed surface and rotating the locating surface of processed workpiece A1 (the processed surface has been turned and locating surface has been rotated);
\textcircled{12} Truss manipulator grabs processed workpiece A1 (the processed surface has been turned and locating surface has been rotated) through the clamping jaw grasping mechanism, and moves and place it on material tray I;

Continuously repeat the above cycle until all workpieces on the material tray have completed all processes, without manual turning, saving time and effort, and the production of finished products is automatically completed by a single machine.

### Embodiment 2

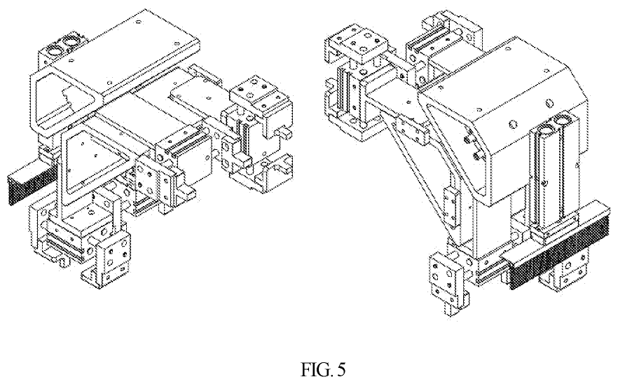

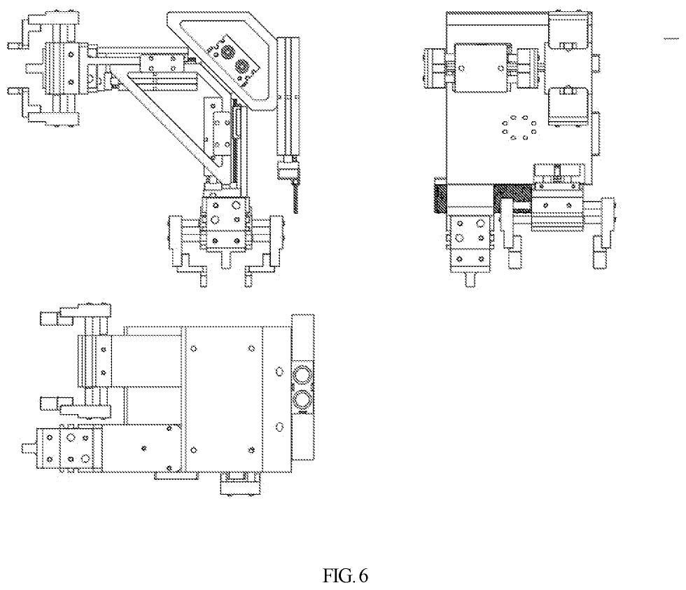

For the second multi processed surface automatic turning mechanism and locating surface rotation mechanism shown in FIG. 4-6: the multi processed surface automatic turning mechanism includes the third and seventh telescopic mechanisms (provided with the corresponding third and seventh power mechanisms), second and sixth rotation mechanisms (provided with the corresponding second and sixth power mechanisms), with the fifth and sixth clamping jaws; the third and seventh telescopic mechanisms are disposed on the second fixed bracket, the second rotation mechanism is disposed on the third telescopic mechanism, the sixth rotation mechanism is disposed on the seventh telescopic mechanism, the fifth clamping jaw is disposed on the second rotation mechanism, and the sixth clamping jaw is disposed on the sixth rotation mechanism; the locating surface rotation mechanism includes the fourth, fifth, sixth, eighth, ninth, and tenth telescopic mechanisms (provided with the corresponding fourth, fifth, sixth, eighth, ninth, and tenth power mechanisms), the third, fourth, fifth, seventh, eighth, and ninth rotation mechanisms (provided with the corresponding third, fourth, fifth, seventh, eighth, and ninth power mechanisms), and material trays II, III, IV, V, VI, and VII.

The first, second, and third guide rails of truss manipulator perform linear motion, with 3-axis linkage, and move according to program settings;

The first rotation mechanism disposed at the flange end of the third movable bracket of truss manipulator moves along with the truss manipulator; the first rotation mechanism can rotate 180° and convert the four clamping jaws on the mechanism;

The first and second telescopic mechanisms disposed on the first rotation mechanism can drive the first and second clamping jaws;

The first, second, third, fourth, fifth, and sixth clamping jaw mechanisms are used to grasp and place the processed workpiece;

Material trays I, II, III, IV, V, VI, and VII are used to place processed workpieces;

The third, fourth, fifth, sixth, seventh, eighth, ninth, and tenth telescopic mechanisms are disposed on the second fixed bracket;

The third telescopic mechanism is provided with a second rotation mechanism, and can drive the second rotation mechanism to perform telescopic motion in X-axis direction; the second rotation mechanism is provided with a fifth clamping jaw, and can drive the fifth clamping jaw to rotate around the X-axis and turn the workpiece processed surface; the fifth clamping jaw can grasp and place workpieces;

The fourth telescopic mechanism is provided with a third rotation mechanism, and can drive the third rotation mechanism to perform telescopic motion in the Z-axis; the third rotation mechanism is provided with material tray II, and can drive material tray II to rotate around the Z-axis and rotate the locating surface; Material tray II can hold workpieces;

The fifth telescopic mechanism is provided with a fourth rotation mechanism, and can drive the fourth rotation mechanism to perform Z-axis telescopic motion; the fourth rotation mechanism is provided with material tray III, and can drive material tray III to rotate around the Z-axis and rotate the locating surface; Material tray III can hold workpieces;

The sixth telescopic mechanism is provided with a fifth rotation mechanism, and can drive the fifth rotation mechanism to perform Z-axis telescopic motion; the fifth rotation mechanism is provided with material tray IV, and can drive material tray IV to rotate around the Z-axis and rotate the locating surface; material tray IV is provided with a rotation mechanism that allows for telescopic motion in the Y-axis direction; the sixth rotation mechanism is provided with a sixth clamping jaw, and can drive the sixth clamping jaw to rotate around the Y-axis and turn the workpiece processed surface; the sixth clamping jaw can grasp and place workpieces.

The eighth telescopic mechanism is provided with a seventh rotation mechanism, and can drive the seventh rotation mechanism to perform telescopic motion in the Z-axis direction; the seventh rotation mechanism is provided with material tray V, and can drive material tray V to rotate around the Z-axis and rotate the locating surface; Material tray V can hold workpieces;

The ninth telescopic mechanism is provided with an eighth rotation mechanism, and can drive the eighth rotation mechanism to perform telescopic motion in Z-axis direction; the eighth rotation mechanism is provided with material tray VI, and the seventh rotation mechanism can drive material tray VI to rotate around the Z-axis and rotate the locating surface; Material tray VI can hold workpieces;

The tenth telescopic mechanism is provided with a ninth rotation mechanism, and can drive the ninth rotation mechanism to perform telescopic motion in Z-axis; the ninth rotation mechanism is provided with material tray VII, and can drive material tray VII to rotate around the Z-axis and rotate the locating surface; Material tray VII can hold workpieces;

The second articulated manipulator for automatic turning CNC equipment with multi processed surface automatic turning and locating surface rotation mechanism performs loading and unloading according to the following processes:
\textcircled{1} Manually place unprocessed workpieces on material tray I of material preparation rack;
\textcircled{2} Through the clamping jaw grasping mechanism, Truss manipulator grabs unprocessed workpiece A from material tray I and sends it to the appropriate position of workbench clamp at the CNC machining center, takes away the processed workpiece (no processed workpiece for the first time) and places unprocessed workpiece A on the workbench clamp which clamps automatically;
\textcircled{3} Truss manipulator leaves CNC machining center and moves to the vicinity of material tray II (or material tray V);
\textcircled{4} During workpiece machining at CNC machining center, truss manipulator places processed workpieces (no processed workpieces for the first time) onto material tray II (or material tray V);
\textcircled{5} Processed workpieces are placed on material tray III (or material tray IV, material tray VI, and material tray VII) by the multi processed surface automatic turning mechanism, and the processed surface is turned by 90°, 180° or not turned, and through the locating surface rotation mechanism, the locating surface is rotated (no processed workpiece for the first time);
\textcircled{6} Through the clamping jaw grasping mechanism, truss manipulator grabs processed workpieces (no processed workpieces for the first time) from material tray II (or material tray III, material tray IV, material tray V, material tray VI, and material tray VII), moves and places them on material tray I;
\textcircled{7} Truss manipulator grabs the second unprocessed workpiece B from material tray I through the clamping jaw grasping mechanism, and moves it outside the CNC machining center;
\textcircled{8} After CNC machining center completes processing, truss manipulator moves to the vicinity of workbench clamp at CNC machining center, grabs processed workpiece A1 through the clamping jaw grasping mechanism, places unprocessed workpiece B on the workbench clamp which clamps automatically;
\textcircled{9} Truss manipulator leaves CNC machining center and moves to the vicinity of material tray II (or material tray V);
\textcircled{10} During workpiece processing at CNC machining center, truss manipulator places processed workpiece A1 onto material tray II (or material tray V);
\textcircled{11} Processed workpieces are placed on material tray III (or material tray IV, material tray VI, and material tray VII) by the multi processed surface automatic turning mechanism, and the processed surface is turned by 90°, 180° or not turned, and through the locating surface rotation mechanism, the locating surface is rotated (the processed surface has been turned and locating surface has been rotated);
\textcircled{12} Truss manipulator grabs processed workpiece A1 (the processed surface has been turned and locating surface has been rotated) through the clamping jaw grasping mechanism, and moves and place it on material tray I;

Continuously repeat the above cycle until all workpieces on the material tray have completed all processes, without manual turning, saving time and effort, and the production of finished products is automatically completed by a single machine.

The above are only the preferred embodiments of the present invention, however, the scope of protection of the present invention is not limited to this. Any equivalent substitution or change made by any person skilled in the art within the technical scope disclosed in the present invention based on the technical solution and its improved concept of the present invention shall be covered within the scope of protection of the present invention.

1. An automatic material turning CNC equipment loading & unloading machine, comprising a truss manipulator (1), wherein the truss manipulator (1) is provided with a clamping jaw grasping mechanism having four clamping jaws, the truss manipulator is fixedly connected to a material preparation rack that is provided with a multi processed surface automatic turning mechanism, a locating surface rotation mechanism, and material tray I.

2. The automatic material turning CNC equipment loading & unloading machine according to claim 1, wherein the truss manipulator is installed on the ground, used to drive the clamping jaw grasping mechanism to move according to the programmed trajectory, and to load and unload materials for the CNC equipment, the truss manipulator (1) comprises a first fixed bracket (225), the outer end of the first fixed bracket (225) is connected to a first guide rail and a second fixed bracket (2), the outer end of the first guide rail is connected to a first movable bracket, the outer end of the first movable bracket is connected to a second guide rail, the outer end of the second guide rail is connected to a second movable bracket, the outer end of the second movable bracket is connected to a third guide rail, and the outer end of the third guide rail is connected to a third movable bracket.

3. The automatic material turning CNC equipment loading & unloading machine according to claim 1, wherein the clamping jaw grasping mechanism comprises a first rotation mechanism (302), a first clamping jaw grasping mechanism, a second clamping jaw grasping mechanism, a third clamping jaw grasping mechanism, and a fourth clamping jaw grasping mechanism, the first rotation mechanism is installed on the third movable bracket, the first clamping jaw (305), the second clamping jaw (307), the third clamping jaw (308), and the fourth clamping jaw (301) are divided into two groups, the first group includes the first and second clamping jaw grasping mechanisms, respectively provided with the first and second telescopic mechanisms, and the second group includes the third and fourth clamping jaw grasping mechanisms.

4. The automatic material turning CNC equipment loading & unloading machine according to claim 1, wherein the multi processed surface automatic turning mechanism comprises a third telescopic mechanism (201), a fourth telescopic mechanism (206), a second rotation mechanism (202) and a third rotation mechanism (204), and the third telescopic mechanism and the fourth telescopic mechanism are disposed on the second fixed bracket (2), the second rotation mechanism (202) is disposed on the third telescopic mechanism (201), the third rotation mechanism (204) is disposed on the fourth telescopic mechanism (206), the fifth clamping jaw (203) is disposed on the second rotation mechanism (202), and the sixth clamping jaw (215) is disposed on the third rotation mechanism (204); the locating surface rotation mechanism includes a fifth telescopic mechanism (209) and a fourth rotation mechanism (207).

5. The automatic material turning CNC equipment loading & unloading machine according to claim 1, wherein material tray I (226), material tray II (205), material tray III (208), material tray IV (211), material tray V (222), material tray VI (216), and material tray VII (218) are provided with a plurality of clamping positions according to the needs of processed workpiece.
